(19) United States
(12) Patent Application Publication
(10) Pub. No.: US 2025/0036285 A1
(43) Pub. Date: Jan. 30, 2025

(54) METHOD AND SYSTEM FOR TRACKING AND MOVING PAGES WITHIN A MEMORY HIERARCHY

(71) Applicant: Enfabrica Corporation, Mountain View, CA (US)

(72) Inventors: Shrijeet Mukherjee, Mountain View, CA (US); Thomas Norrie, Mountain View, CA (US); Jay Peterson, Mountain View, CA (US)

(21) Appl. No.: 18/785,542

(22) Filed: Jul. 26, 2024

Related U.S. Application Data
(60) Provisional application No. 63/529,623, filed on Jul. 28, 2023.

(51) Int. Cl. G06F 3/06

(52) U.S. Cl. CPC G06F 3/0611; G06F 3/0655; G06F 3/0679

(57) ABSTRACT

A system for tracking and moving pages within a memory hierarchy is disclosed. In some embodiments, the system comprises a memory hierarchy having low-tier memory and high-tier memory. The system comprises an input/output (I/O) port configured to map into the low-tier memory. The system comprises a central processing unit (CPU) associated with the high-tier memory and configured to make one or more page requests for accessing a page stored in the low-tier memory via the I/O port. The system also comprises a page tracker configured to determine a count of the one or more page requests. The system further comprises a data movement engine configured to move content of the page from the low-tier memory to the high-tier memory when the count of the one or more page requests exceeds a predetermined threshold.

### CROSS REFERENCE TO RELATED APPLICATION

This application claims the benefit of U.S. Provisional Patent Application No. 63/529,623, titled “Method and System for Tracking and Moving Pages within a Memory Hierarchy,” and filed on Jul. 28, 2023, the entire contents of which are incorporated by reference herein.

### FIELD OF TECHNOLOGY

The present disclosure relates generally to memory hierarchies used in modern computer architectures. More specifically, in certain examples, the present disclosure relates to a method and system that minimizes latency during data transfers in a memory cache coherency environment by: (i) tracking frequently accessed pages (referred to as “hot pages”) stored in external memories operated under a Compute Express Link (CXL) protocol, and (ii) moving the hot pages from the CXL memory tier to a higher performance local Double Data Rate (DDR) layer using a Direct Memory Access (DMA) engine featuring a page queue interface.

### BACKGROUND

Exponential data growth is prompting the computing industry to embark on a groundbreaking architectural shift to fundamentally change the performance, efficiency, and cost of data centers. To advance performance, servers are moving increasingly to heterogenous computing architectures with purpose-built accelerators offloading specialized workloads from central processing units (CPUs). CXL memory cache coherency allows for sharing of memory resources between CPUs and accelerators.

CXL is an open standard industry-supported cache-coherent interconnect for processors, memory expansion, and accelerators. Essentially, CXL technology maintains memory coherency between CPU memory space and memory on attached devices. This enables resource sharing (or pooling) for higher performance, reduces software stack complexity, and increases utilization efficiency to lower overall system cost. CXL memory expansion capabilities enable additional capacity and bandwidth above and beyond the direct-attach Dual In-line Memory Module (DIMM) slots in today's servers. CXL makes it possible to add more memory to a CPU host processor through a CXL-attached device. When paired with persistent memory, the CXL link allows the CPU host to use this additional memory in conjunction with its dynamic random-access memory (DRAM).

The existing CXL approach, however, comes with various challenges and shortcomings. For instance, when CXL is used as a memory expansion method for adding a new layer of memory to a memory hierarchy, the CPU's memory controller may be unable to balance the load across all memory components of the memory hierarchy with efficiency. This can result in large latency swings (e.g., between 40-60 ns and 400-600 ns) when transferring data from a CXL attached memory. The load balancing issue may be further exacerbated when data structures being frequently accessed straddle pages from a local DDR memory and a CXL memory.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

To address the shortcomings mentioned above, a method and system for minimizing latency during data transfers in a memory cache coherency environment are disclosed herein. According to some embodiments, the method and system (i) track frequently accessed pages (“hot pages”) stored in external memories operated under a CXL protocol, and (ii) move the hot pages from the CXL memory tier to a higher performance local DDR layer utilizing a DMA engine featuring a page queue interface.

In some embodiments, a hot page tracking table may be used to monitor or maintain a count or count frequency of accesses (e.g., write, read) to pages on each input/output (I/O) port. For example, a count or number of read and/or write requests for each page and/or each I/O port (e.g., over a period of time) can be logged in the tracking table. The counts may be compared with one or more thresholds so that hot pages (or content thereof) can be moved quickly when a load on that port is high. In some examples, a threshold may be a function of the load on that port, and one or more thresholds may be adjusted based on the aggregate load to the port. This can allow a highly loaded port to be aggressive with page move requests.

In some embodiments, a system for hiding memory access latency in a heterogeneous compute environment is disclosed. The disclosed system may track and move pages between tiers within a memory hierarchy, for example, to identify hot pages and move content of the hot pages from high-latency tiers to low-latency tiers. The disclosed system may include: a memory hierarchy having low-tier memory and high-tier memory; an I/O port configured to map into the low-tier memory; a central processing unit (CPU) associated with the high-tier memory and configured to make one or more page requests for accessing a page stored in the low-tier memory via the I/O port; a page tracker configured to determine a count of the one or more page requests; and a data movement engine configured to move content of the page from the low-tier memory to the high-tier memory when the count of the one or more page requests exceeds a predetermined threshold.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles, and features explained herein may be employed in various and numerous embodiments.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 illustrates an exemplary central processing unit (CPU) page mapping model, according to some embodiments.

FIG. 2 illustrates an exemplary memory hierarchy having a combination of double data rate (DDR) and compute express link (CXL)-based memory in an interleaved mode, according to some embodiments.

FIG. 3 illustrates a model for moving contents from pages in a lower tier CXL-based memory into a higher tier memory as the usage of the page contents exceeds a threshold, according to some embodiments.

FIG. 4 illustrates an improved model for moving contents from pages in a lower tier CXL-based memory into a higher tier memory as the usage of the page contents exceeds a threshold, according to some embodiments.

FIG. 5 illustrates an exemplary process for hiding memory access latency in a heterogenous compute environment, according to some embodiments.

FIG. 6 illustrates an exemplary accelerated compute fabric architecture for accelerated and/or heterogeneous computing systems in a data center network, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

A goal of modern computer architectures is to provide memory hierarchies that efficiently balance latency and capacity. In an ideal scenario, a highest level/layer in a hierarchy would have sufficient capacity to fit an entire context of an operation to be executed by the CPU so that fetching from another level is no longer required, which means the latency associated with fetching between levels is eliminated.

The latest attempt to solve this problem is a technology known as CXL.memory (alternatively referred to herein as “CXL Memory” or “CXL-based memory”), which operates as a logical memory, non-uniform memory access (NUMA) node in a collection of CPUs (also referred as to CPU hosts hereafter). Essentially, CXL technology can add memory resources into a system via Input/Output (I/O) slots. The most useful variation of CXL.memory is referred to as an interleaved mode, where pages from various parts of the memory hierarchy, such as local DRAM and CXL-attached DRAM, are mixed into a single virtual memory space.

The method and system disclosed herein allow the external memory (in CXL or any other memory form) to identify which pages in the CXL.memory portion of the hierarchy have been frequently accessed, and enable a method of moving the frequently accessed pages (hereafter referred to as “hot pages”) from a higher-latency lower-performance CXL.memory layer to a lower-latency higher-performance CPU or GPU local DDR layer.

### Overview

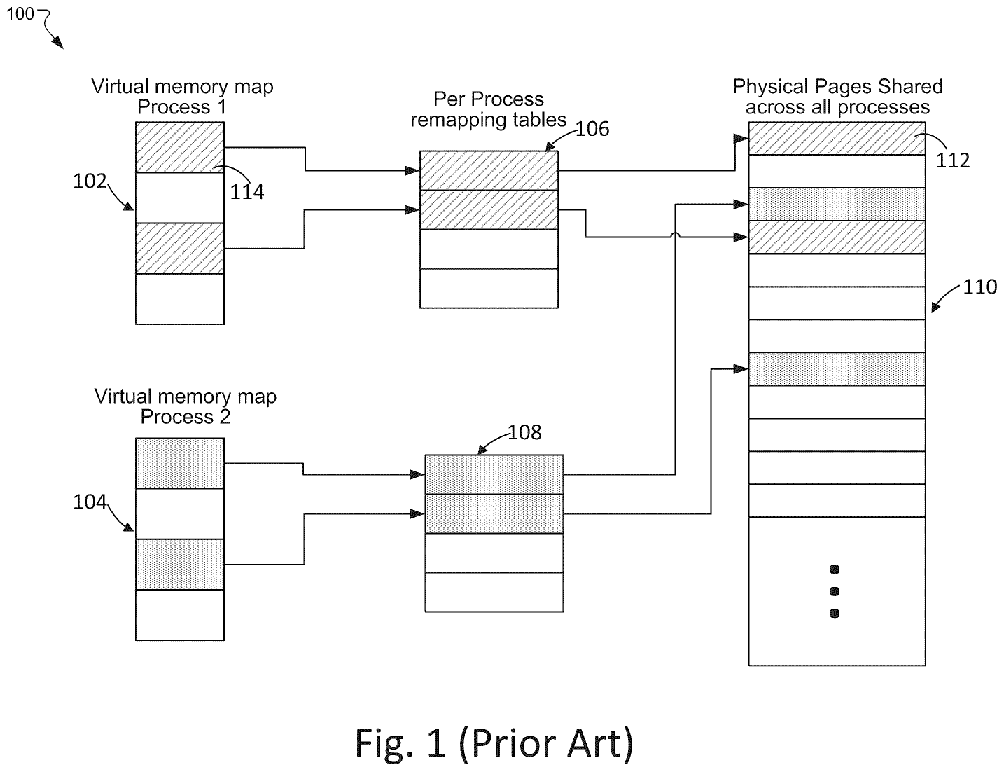

FIG. 1 illustrates a CPU page mapping model 100 that maps addresses or pages in virtual memory to corresponding addresses or pages in physical memory, according to some embodiments. In various examples, a “page,” “memory page,” or “virtual page” can be or include a fixed-length contiguous block of memory. A page is usually described by a single entry in a page table. A page can be the smallest data unit for memory management in a virtual memory operating system. In various examples, physical memory pages can be scattered by design across a large pool of memory chips, for example, arranged in various banks, ranks, and/or Dual In-line Memory Modules (DIMMs).

As depicted in FIG. 1, for processes being executed by one or more processors (e.g., including process 1 and process 2), a virtual memory map (e.g., 102 or 104) can be used along with a remapping table (e.g., 106 or 108) to where the corresponding physical pages are stored at physical memory 110. For example, the mapping tables 102 and 106 can be used to identify a physical page 112 corresponding to a virtual page 114 for process 1. In various examples, the locations of physical pages in the physical memory 110 can be tracked by a Memory Management Unit (MMU) of the CPU and a memory controller (MC), which can manage memory pools attached to or associated with the MC.

The memory mapping becomes complicated when multiple hierarchies of memory are attached to the CPU where each level of a hierarchy provides different bandwidths and latencies, such as with DDR and CXL. With non-hierarchical memory, the load can be distributed evenly across all controllers and DIMMs. In general, however, this does not work well for hierarchical memory because an even distribution may cause overall workload processing to be slowed down by the slower-tier memory components.

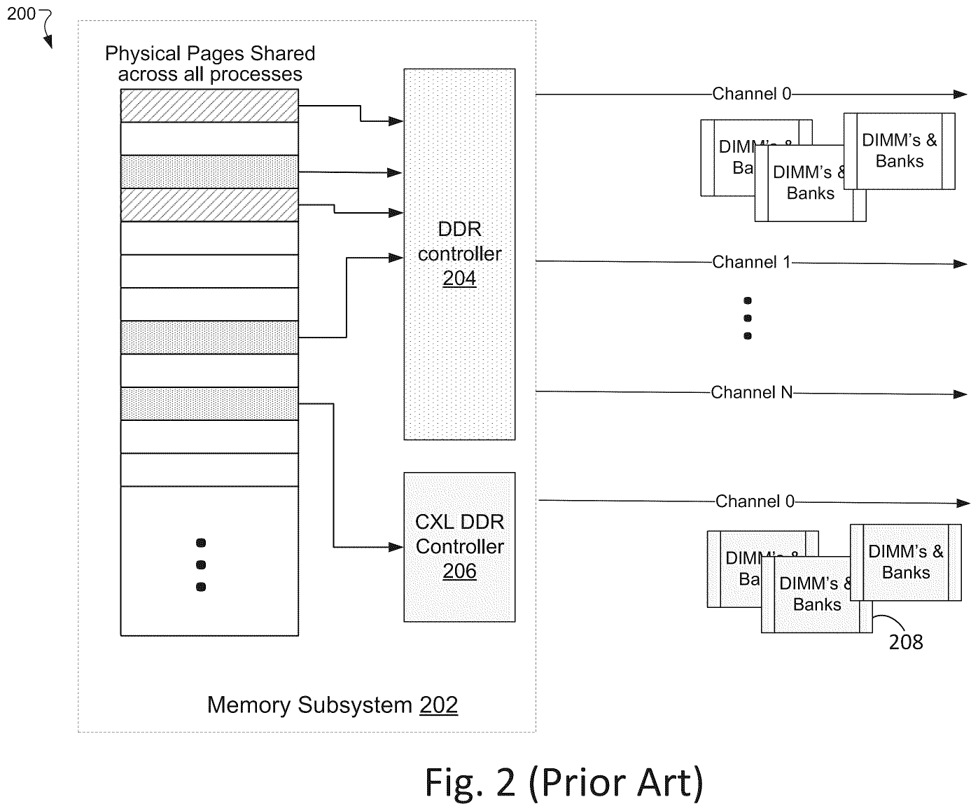

FIG. 2 illustrates an exemplary memory hierarchy 200 with a combination of local DDR and CXL-based memory in an interleaved mode. In various examples, a memory subsystem 202 in the hierarchy 200 is unable to autonomously move pages around based on dynamic load information, since page mapping is typically controlled by an Operating System (OS). Also, as noted above for FIG. 1, the virtual memory map can include virtual-to-physical page tables (e.g., remapping tables 106, 108) that provide an additional layer of indirection. This makes it even harder to track the map of an application's virtual address to a specific layer of the memory hierarchy. Thus, the memory subsystem 202 may end up as a fractured memory model that results in large latency swings with a latency variation ranging from 40-60 ns for local DDR to 400-600 ns for CXL-attached memory. As depicted, controllers such as the local DDR controller 204 and CXL DDR controller 206 may be used to control data transfers of the physical memory pages arranged in DIMMs and banks 208. The latency can be greater when there is a data structure that is accessed frequently and straddles a page from local DDR and a page from CXL memory.

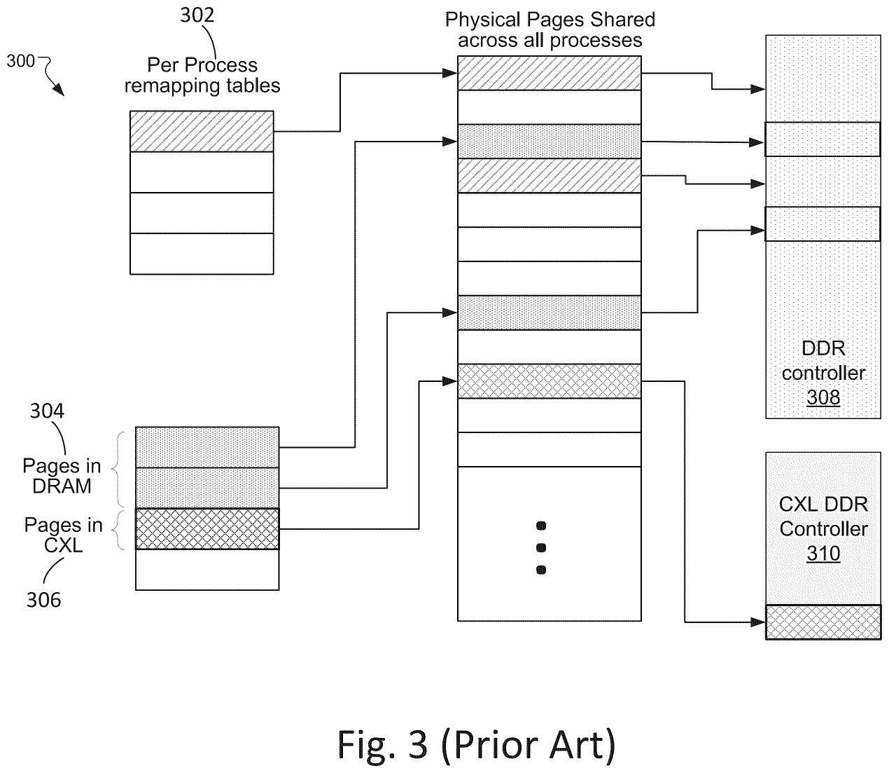

A logical solution to this problem would be to keep track of which pages are allocated from which physical pool, and ensure that pages accessed at a very high frequency (e.g., above a specified threshold) are always moved into the local DDR pool so that the CPU can always have the lowest possible access latency. In this way, the most performance-critical pages can be present at the highest tier/layer of the hierarchy, which can be easily and quickly accessed by the CPU. This is shown schematically in model 300 of FIG. 3, where virtual-to-physical page table 302 contains information about the corresponding physical page. In some embodiments, the virtual-to-physical page table 302 may contain attributes of the physical page, including which tier it belongs to (e.g., tier 304 or tier 306), based on the physical address being used or based on information in the page tables. Armed with this knowledge, the OS can move the contents from pages present in a lower tier memory (e.g., CXL) into a higher tier memory when the usage of the contents exceeds a predetermined threshold.

Various criteria may need to be satisfied for the model 300 to be successful. For example, the CPU should be able to efficiently track access frequency to each page in the page table. Also, the model 300 should be able to generate page movements from a high usage frequency CXL page to local DDR in an efficient and non-blocking manner. Further, the model 300 should provide a mechanism for (i) blocking access to a high usage frequency CXL page while it is being migrated and (ii) remapping the virtual range to the pages in the DDR controllers. As used herein, “non-blocking” can refer to an ability to continue executing a CPU thread without stalling while waiting for a page to be moved from one tier of memory into another (which can take a relatively long time).

### Shortcomings of Existing Solutions

Nevertheless, the solution as shown in FIG. 3 is difficult to implement in the current art for various reasons. Here, controllers such as local DDR controller 308, CXL DDR controller 310 may be used to control data transfers to or from the physical memory pages. In general, current CPU designs may be unable to track different physical page pools in different locations within the memory hierarchy, and thus cannot easily provide physical page information. For example, in existing CPU designs, getting the model 300 to work may require remembering when a page is being allocated from a higher latency tier and mapping it as an unavailable page (e.g., unreadable and unwritable). In such a case, each software access can invoke a fault handler. The fault handler can then increment counters, enable the mapping, and allow continued access. This scheme can be extremely expensive from a latency perspective and may not yield any net execution performance advantages.

One possible improvement would involve adding hit or access counters on each of the remapping table entries and including software to periodically check every page that has been hit or accessed to determine if the page associated with the remapping entry is pointing to the CXL memory. The software could then trigger the page movement for all pages that were hit over a period of time and happened to be in CXL memory.

Future CPU designs may have attributes that indicate a memory page residing behind an I/O port as opposed to a directly accessed DDR. But even for those cases, the CPU would be unable to track statistics that represent pages in all levels of the hierarchy because (i) there can be multiple levels of CXL switching for memory connected across a CXL network, and (ii) the CPU does not have visibility into the full CXL network topology.

Further, the ability to move pages quickly and across multiple tiers of memory is unattainable for existing systems because it requires the CPU managing the pages to not only issue the move request but also to perform the memory copy itself. This can add substantial overhead on the CPU because it involves a read operation followed by a write operation for each data unit. The links, over which the read and write operations are issued, can be bandwidth-constrained because the reading and writing of memory for the active threads generally occur simultaneously. An ideal solution would be to have the read data from CXL written directly to DRAM, bypassing the data moving through the CPU core completely (like a DMA operation).

Also, CXL is being built to be a multi-layered, multi-host, memory sharing fabric. This means that memory modules plugged into a single port of a CXL fabric can be shared at a fairly fine granularity across multiple CPUs connected to the fabric, which in turn implies that any CPU-based scheme for tracking pages mapped into CXL memory would need coordination among the CPUs every time a CXL page changes ownership and gets used for higher latency accesses. Furthermore, while the access rate threshold is accurate from the perspective of a single CPU host, the access rate threshold may not accurately reflect the full memory port load in cases where multiple CPU hosts are accessing a tier and collectively exceed the port's bandwidth.

### Solution

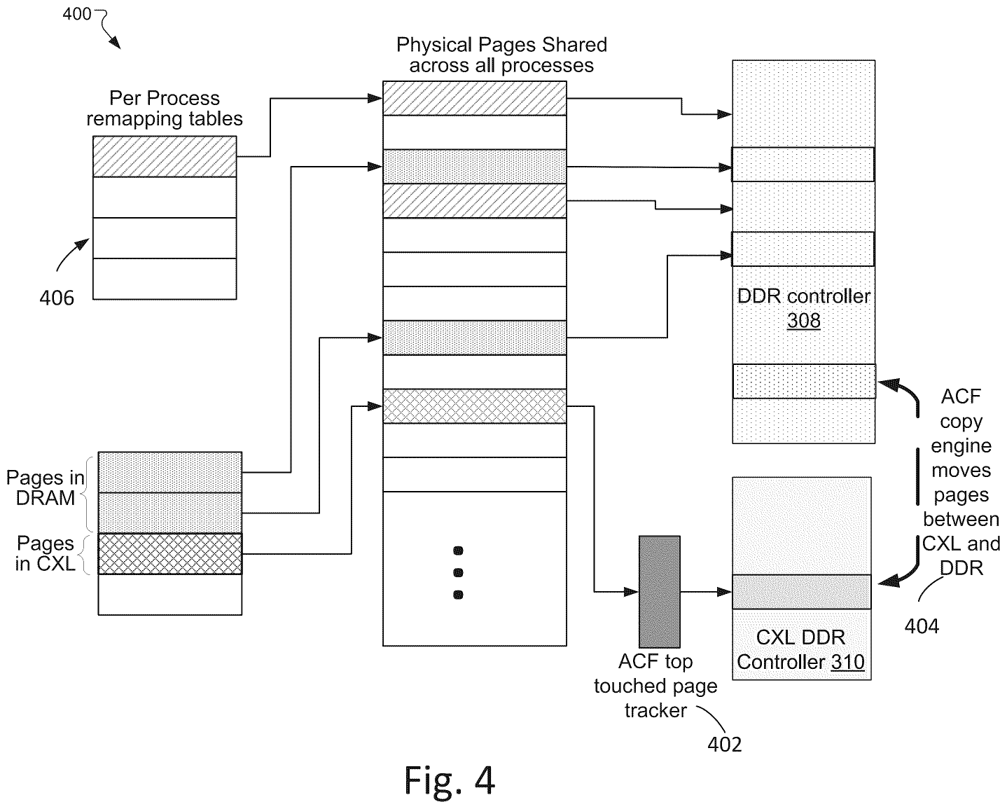

In various examples, a solution that is scalable and applicable without major changes in the CPU infrastructure is described below in connection to FIG. 4. The solution involves a per CXL port hot page tracking table that maintains a count of accesses to pages on that port. Since the port can be mapped into various memory modules and these modules can be shared across a variety of different hosts, the following characteristics related to the hot page tracking table should be considered.

First, since the table can grow to a large size, the CXL port is configured to be efficient in size and representation. Although one solution may be to implement a Content-Addressable Memory (CAM) as a parallel lookup structure where each accessed address is inserted, the CAM-based solution can be prohibitively expensive to implement at the desired scale. For example, a the lookup structure should be able to sparsely represent hundreds of terabytes of memory at four-kilobyte (4 KB) granularity.

Second, the CXL port can support hot page thresholds that can be adjusted based on the aggregate bandwidth load to a given port, such that hot pages can be easily identified when the aggregate load to that port gets above a desired limit or threshold. By way of example and not limitation, if a given port is handling memory traffic above 80% of its bandwidth, it may be desirable to move pages to a higher tier memory to reduce the load to that port. Running a port close to 100% utilization may result in high latency variation, which can be detrimental to smooth processing operations.

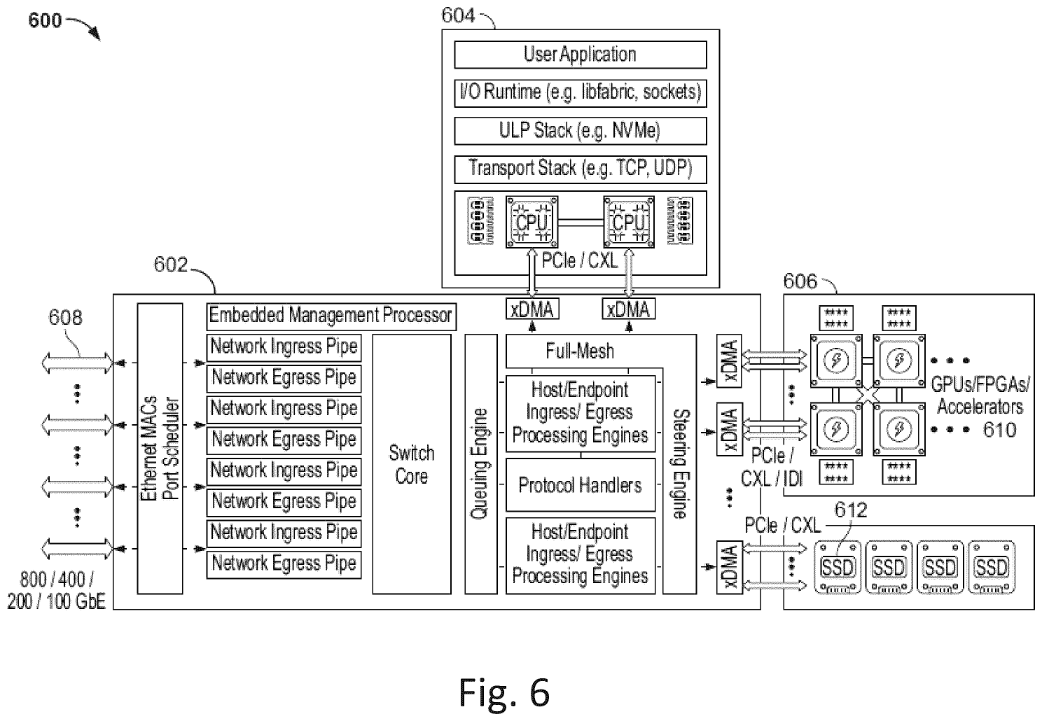

FIG. 4 is a schematic diagram of an improved model 400 for moving a page between two tiers (e.g., CXL and DDR) of a memory hierarchy, for example, when usage (e.g., access count, access frequency) of the page content exceeds a threshold, in accordance with certain examples. In some examples, the threshold is predetermined but can be dynamically adjusted based on the load on a specific port. As depicted, the present system may use a page tracker 402 (alternatively referred to as a tracking table) to keep a count of accesses to pages on each input/output (I/O) port. For example, the page tracker 402 may track and/or count each page request for accessing a page stored in a low-tier memory. The count can be the number of page requests for a page or an access frequency for a page (e.g., the number of page requests within a period of time). A page request can be made by the CPU with a high-tier memory to the low-tier memory via an I/O port. For example, the high-tier memory can be the CPU's main memory, and the main memory can include DDR memory. In some embodiments, the present system includes or utilizes an accelerated compute fabric (ACF) (e.g., as described in FIG. 6). In some embodiments, the page tracker 402 can be or include a counting bloom filter. The counting bloom filter can be or include a generalized data structure of a bloom filter used to test whether a count/number of a given element is smaller than a given threshold when a sequence of elements is given.

There are some unique properties associated with a counting bloom filter. For example, the counting bloom filter can be statistically accurate for the scale of entries for which the filter is designed. The counting bloom filter may be sized to provide statistical guarantees, for example, page aliases (e.g., false positives) can be sufficiently rare at a certain size of the count bloom filter structure and for the size of the workload's active set of accessed pages. This can lower the probability of a cold page (e.g., a page that has not been frequently accessed or not accessed) from being moved as if it were a hot page to the extent that it has no measurable impact on system performance.

In various examples, all lookups with counts exceeding a certain predetermined threshold can be enqueued for the software to process. In some embodiments, the software may examine the addresses in the queue and disambiguate them if necessary. For example, if the addresses are deemed to correspond to a page in a higher latency tier (e.g., CXL memory) that has been accessed frequently, the software may initiate a copy of the page into a lower latency tier (e.g., DDR memory).

In some embodiments, the predetermined threshold may be a function of the load on the port, such that ports with higher loads (e.g., a higher number of access requests) can be more aggressive in requesting page moves compared to ports with lower loads (e.g., a lower number of requests). The above terms “load” and “access” relate to an attempt by a CPU to perform a read or write operation to a memory location on a page in a memory tier. Furthermore, the threshold may be specified per page and/or per port, for example, with each page and/or port having its own threshold. In some implementations, the threshold can be a specific percentage based on tracking the access frequency to a page. In other implementations, the threshold can be a specific number of accesses based on the tracking of the total number of accesses to a page.

The disclosed method and system can provide other unique features. For example, when the page tracker 402 indicates that the access count and/or access count frequency (e.g., requests per time) to a page has exceeded a predetermined threshold, the page may be identified as a hot page and/or may be identified as requiring movement from a low-tier memory (e.g., CXL layer) to a high-tier memory (e.g., DDR layer) in the memory hierarchy. Once the hot page has been flagged for movement, the ACF or other component may utilize a data movement engine or a copy engine (not shown) to implement the move of page content at 404. The data movement engine can include or utilize a page queue interface to facilitate the page content move at 404. In some implementations, the data movement engine is or includes a DMA engine. In some implementations, the page queue interface includes a first queue (e.g., device-side queue) and a second queue (e.g., CPU-side queue) as described below.

In some implementations, the CPU host may reserve a set of pages in locations of a high-tier memory (e.g., faster DDR memory) to which a device (e.g., a graphics processing unit (GPU) or an accelerator) is free to copy pages from a low-tier memory (e.g., slower CXL memory). For example, on the device side, a queue can be populated by the device with CXL addresses to read data from. On the CPU side, a queue can be populated by the CPU (e.g., ahead of time) with DDR addresses to write data to. Accordingly, the device-side queue can be used for queuing pages that need to be moved. By way of example and not limitation, the pages can be enqueued as a list of scattered pages. The CPU-side queue can be used for queuing destination page locations that the pages should be moved to. In some implementations, the pages are pre-reserved and/or pre-populated into the CPU-side queue (e.g., before a page access initiated by a process). In some implementations, the content of a hot page may be transferred from the device-side queue to the CPU-side queue.

In some embodiments, the method and system disclosed herein may utilize an MMU outside the CPU to interact with multiple CPU hosts. These CPU hosts may have independent address spaces but can allocate CXL pages from a shared global pool of CXL memory. In such a case, the MMU outside the CPU hosts may convert the address space of each individual CPU to and from the CXL address the CPU. This is an important aspect of the MMU because, in some examples, the device-side queue operates on the global CXL addresses, while the CPU-side queue operates on the individual CPU addresses to which the pages will be moved.

In some embodiments, the present system may allow the device-side queue contents to be automatically enqueued from the counting bloom filter implementation, and thus initiate the page movement when a predetermined threshold is reached/exceeded. Responsive to the access frequency/count for a page stored in a low-tier memory (e.g., CXL) exceeding the predetermined threshold, the CPU host using the CXL page may mark this hot page as missing. This can result in a page fault on the next access, e.g., with the content of the hot page no longer being accessible. Once access to the page is stalled, a flush operation may be executed to make all data of the page visible to the CXL memory. The data movement engine may then be engaged to move the page content from the CXL memory in the device-side queue to the DDR memory in the CPU-side queue, as shown in 404 of FIG. 4.

In some embodiments, when hardware (e.g., data movement engine) indicates the page movement has been completed, the remapping tables 406 may be updated to point to the physical location in the high-tier memory where the content of the missing hot page has been transferred (e.g., one or more new pages in DDR memory). Access to the transferred content of the hot page can then be re-enabled. The accessing compute thread may be in a wait state for the duration of the page movement operations.

In some embodiments, the hardware may further optimize the above operations by issuing un-map and flush requests directly to the CPU and/or triggering the start of the page movement autonomously. This may be achieved when CXL protocol is configured to allow an endpoint device to generate the “un-map” operation. In some examples, CXL protocol may enable only endpoint devices to request such un-mapping and/or flushes.

### Flow Diagram

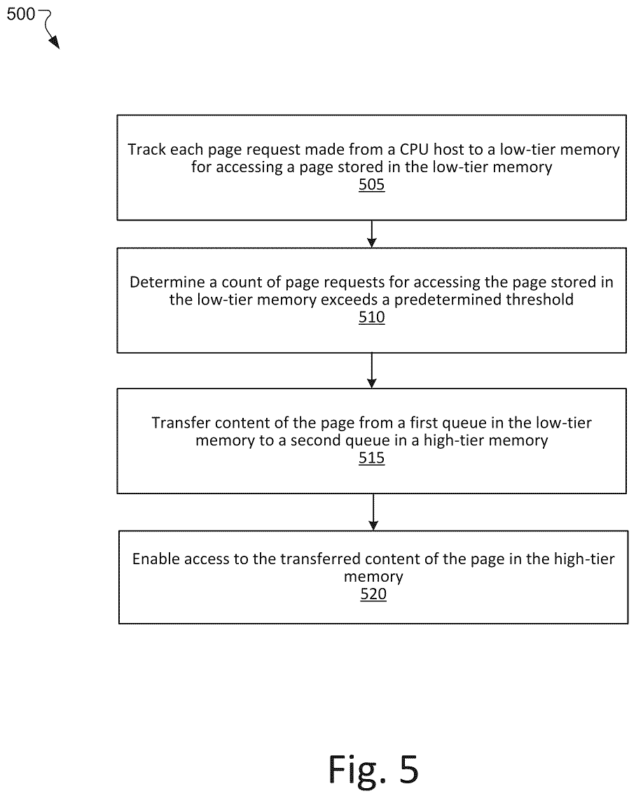

FIG. 5 illustrates an exemplary process 500 for hiding memory access latency in a heterogeneous compute environment. In some embodiments, the process 500 can involve tracking and moving pages between tiers within a memory hierarchy, for example, to avoid or minimize latency issues associated with hot pages being located in low-tier memory (e.g., a high-latency tier). Process 500 is implemented by an ACF (e.g., ACF 602 shown in FIG. 6) that is communicatively connected over system I/O interfaces with a variety of devices (e.g., accelerators or memory devices).

At step 505, each page request is tracked. A page request is made from a CPU host to a low-tier memory via an I/O port for accessing a page stored in the low-tier memory. In some embodiments, a page tracker (e.g., including a counting bloom filter) is used to track and/or count the page requests from the CPU to the low-tier memory. In some embodiments, the low-tier memory is a CXL-based memory, and the CPU is associated with a high-tier memory such as a DDR memory.

At step 510, a count of page requests for accessing the page stored in the low-tier memory is determined. When the count (or count frequency, e.g., in counts per unit of time) exceeds a predetermined threshold, the page can be considered a hot page for which the content of the page should be moved to a high-tier memory. For example, when an access frequency for the page exceeds a predetermined threshold, the content of the page can be moved to a higher tier memory (e.g., to reduce a load on the I/O port through which the access request for the page was made). In some embodiments, the predetermined threshold is a function of a load on the I/O port and/or can be adjusted based on an aggregate bandwidth load.

At step 515, the content of the page is transferred from a first queue in the low-tier memory (e.g., CXL memory) to a second queue in a high-tier memory (e.g., DDR memory). In some embodiments, when the predetermined threshold is exceeded, the CPU host using the low-tier memory may mark the page as missing and/or may otherwise trigger a page fault and stall access to the page. A flush operation may then be executed to make all data of the page visible to the CXL memory to cause the transfer of the page content. In some embodiments, the first queue is a device-side queue for queuing the hot page to be moved, and the second queue is a CPU-side queue for queuing one or more destination page locations to which the hot page should be moved.

At step 520, the transferred content of the page in the high-tier memory is enabled. In some embodiments, in response to the content being transferred, a remapping table is updated to point to a physical location in the high-tier memory where the content of the page has been transferred. The transferred content of the page in the high-tier memory is thus enabled.

While certain examples described herein (e.g., including the process 500) relate to moving content from low-tier memory to high-tier memory, the systems and methods described herein can likewise be used to move content from high-tier memory to low-tier memory. For example, when the count of page requests for a page in high-tier memory is determined to be less than or equal to a predetermined threshold (e.g., the page is inactive and/or is not a hot page), the content of the page may be transferred from the high-tier memory to low-tier memory. The predetermined threshold can be the same as or different from a threshold used to move content from low-tier memory to high-tier memory, as described herein.

### Implementation System

FIG. 6 illustrates an exemplary accelerated compute fabric architecture 600 for accelerated and/or heterogeneous computing systems in a data center network. The accelerated compute fabric (ACF) 602 of FIG. 6 may be used to implement the page data movement mechanism described herein and shown in FIGS. 4 and 5. In some embodiments, ACF 602 may connect to one or more controlling hosts 604, one or more endpoints 606, and one or more Ethernet ports 608. An endpoint 606 may be a GPU, accelerator, FPGA, etc. Endpoint 606 may also be a storage or memory element 612 (e.g., SSD), etc. ACF 602 may communicate with the other portions of the data center network via the one or more Ethernet ports 608.

In some embodiments, the interfaces between ACF 602 and controlling host CPUs 604 and endpoints 606 are shown as over PCIe/CXL or similar memory-mapped I/O interfaces. In addition to PCIe/CXL, ACF 602 may also communicate with a GPU/FPGA/accelerator 610 using wide and parallel inter-die interfaces (IDI) such as Just a Bunch of Wires (JBOW). The interfaces between ACF 602 and GPU/FPGA/accelerator 610 are therefore shown as over PCIe/CXL/IDI.

ACF 602 is a scalable and disaggregated I/O hub, which may deliver multiple terabits-per-second of high-speed server I/O and network throughput across a composable and accelerated compute system. In some embodiments, ACF 602 may enable uniform, performant, and elastic scale-up and scale-out of heterogeneous resources. ACF 602 may also provide an open, high-performance, and standard-based interconnect (e.g., 800/400 GbE, PCIe Gen 5/6, CXL). ACF 602 may further allow I/O transport and upper layer processing under the full control of an externally controlled transport processor. In many scenarios, ACF 602 may use the native networking stack of a transport host and enable ganging/grouping of the transport processors (e.g., of x86 architecture).

As depicted in FIG. 6, ACF 602 connects to one or more controlling host CPUs 604, endpoints 606, and Ethernet ports 608. A controlling host CPU or controlling host 604 may provide transport and upper layer protocol processing, act as a user application “Master,” and provide infrastructure layer services. An endpoint 606 (e.g., GPU/FPGA/accelerator 610, storage 612) may be producers and consumers of streaming data payloads that are contained in communication packets. An Ethernet port 608 is a switched, routed, and/or load balanced interface that connects ACF 602 to the next tier of network switching and/or routing nodes in the data center infrastructure

In some embodiments, ACF 602 is responsible for transmitting data at high throughput and low predictable latency between:
Network and Host;
Network and Accelerator;
Accelerator and Host;
Accelerator and Accelerator; and/or
Network and Network.

In general, when transmitting data/packets between the entities, ACF 602 may separate/parse arbitrary portions of a network packet and map each portion of the packet to a separate device PCIe address space. In some embodiments, an arbitrary portion of the network packet may be a transport header, an upper layer protocol (ULP) header, or a payload. ACF 602 is able to transmit each portion of the network packet over an arbitrary number of disjoint physical interfaces toward separate memory subsystems or even separate compute (e.g., CPU/GPU) subsystems.

By identifying, separating, and transmitting arbitrary portions of a network packet to separate memory/compute subsystems, ACF 602 may promote the aggregate packet data movement capacity of a network interface into heterogeneous systems consisting of CPUs, GPUs/FPGAs/accelerators, and storage/memory. ACF 602 may also factor, in the various physical interfaces, capacity attributes (e.g., bandwidth) of each such heterogeneous systems/computing components.

In some embodiments, ACF 602 may interact with or act as a memory manager. ACF 602 provides virtual memory management for every device that connects to ACF 602. This allows ACF 602 to use processors and memories attached to it to create arbitrary data processing pipelines, load balanced data flows, and channel transactions towards multiple redundant computers or accelerators that connect to ACF 602. Moreover, the dynamic nature of the memory space associations performed by ACF 602 may allow for highly powerful failover system attributes for the processing elements that deal with the connectivity and protocol stacks of system 600.

### Additional Considerations

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer-readable medium. The storage device 830 may be implemented in a distributed way over a network, for example as a server farm or a set of widely distributed servers, or may be implemented in a single computing device.

Although an example processing system has been described, embodiments of the subject matter, functional operations, and processes described in this specification can be implemented in other types of digital electronic circuitry, in tangibly-embodied computer software or firmware, in computer hardware, including the structures disclosed in this specification and their structural equivalents, or combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other units suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for hiding memory access latency in a heterogeneous compute environment, the system comprising:
a memory hierarchy having low-tier memory and high-tier memory;
an input/output (I/O) port configured to map into the low-tier memory;
a central processing unit (CPU) associated with the high-tier memory and configured to make one or more page requests for accessing a page stored in the low-tier memory via the I/O port;
a page tracker configured to determine a count of the one or more page requests; and
a data movement engine configured to move content of the page from the low-tier memory to the high-tier memory when the count of the one or more page requests exceeds a predetermined threshold.

2. The system of claim 1, wherein the data movement engine comprises a page queue interface comprising (i) a first queue for queuing the content of the page from the low-tier memory and (ii) a second queue for queuing destination page locations in the high-tier memory for receiving the content of the page, and
wherein, to move the content of the page from the low-tier memory to the high-tier memory, the data movement engine is further configured to use the page queue interface to transfer the content of the page from the first queue in the low-tier memory to the second queue in the high-tier memory.

3. The system of claim 2, wherein the first queue is a device-side queue and the second queue is a CPU-side queue.

4. The system of claim 1, wherein the page tracker utilizes a counting bloom filter.

5. The system of claim 1, wherein the data movement engine is further configured to move content of a page stored in the high-tier memory to the low-tier memory based on a count of page requests.

6. The system of claim 1, wherein the low-tier memory is a Compute Express Link (CXL) memory, and the high-tier memory is the CPU's main memory comprising a Double Data Rate (DDR) memory.

7. The system of claim 1, wherein the predetermined threshold is a function of a load on the I/O port, and the load is indicative of a number of page requests made by the CPU via the I/O port for a respective page.

8. The system of claim 7, wherein the threshold is adjustable based on an aggregate bandwidth load to the I/O port.

9. The system of claim 1, wherein, in response to the count of the one or more page requests exceeding the predetermined threshold, the CPU is further configured to mark the page as missing to trigger a page fault.

10. The system of claim 1, wherein the data movement engine is further configured to:
update a remapping table to point to a physical location in the high-tier memory where the content of the page has been transferred to; and
enable access to the transferred content of the page in the high-tier memory.

11. A method of hiding memory access latency in a heterogeneous compute environment, the method comprising:
providing a memory hierarchy having low-tier memory and high-tier memory;
tracking page requests made from a central processing unit (CPU) for accessing a page stored in the low-tier memory;
determining that a count of the page requests exceeds a predetermined threshold;
transferring, in response to the determination, content of the page from the low-tier memory to the high-tier memory; and
enabling access to the transferred content in the high-tier memory.

12. The method of claim 11, further comprising, in response to determining that the count of the page requests exceeds the predetermined threshold, marking the page as missing to trigger a page fault.

13. The method of claim 11, further comprising, in response to transferring the content of the page, updating a remapping table to point to a physical location in the high-tier memory where the content of the page has been transferred to.

14. The method of claim 11, wherein the content of the page is transferred from a first queue in the low-tier memory to a second queue in the high-tier memory, and wherein the first queue is a device side queue and the second queue is a CPU side queue.

15. The method of claim 14, wherein the first queue and the second queue form at least a portion of a page queue interface of a data movement engine.

16. The method of claim 11, further comprising moving content of a page stored in the high-tier memory to the low-tier memory based on a count of page requests.

17. The method of claim 11, wherein the low-tier memory is a Compute Express Link (CXL) memory, and the high-tier memory is the CPU's main memory comprising a Double Data Rate (DDR) memory.

18. The method of claim 11, wherein the predetermined threshold is a function of a load on an input/output (I/O) port, and the load is indicative of a number of page requests made by the CPU via the I/O port for a respective page.

19. The method of claim 18, wherein the threshold is adjustable based on an aggregate bandwidth load to the I/O port.

20. The method of claim 11, wherein tracking each page request is implemented using a page tracker, and wherein the page tracker utilizes a counting bloom filter.
